(19) United States
(12) Patent Application Publication
(10) Pub. No.: US 2026/0297762 A1
(43) Pub. Date: Oct. 1, 2026

(54) DEVICES, SYSTEMS, AND METHODS FOR THE ELECTROCHEMICAL GENERATION OF BASE/ACID AND DEIONIZATION OF SALINE WATER

(71) Applicant: Capture6 Corp, Berkeley, CA (US)

(72) Inventors: Sohum Patel, New Haven, CT (US); Rahul Surana, Fremont, CA (US)

(73) Assignee: Capture6 Corp, Berkeley, CA (US)

(21) Appl. No.: 19/578,513

(22) Filed: Mar. 25, 2026

Related U.S. Application Data
(60) Provisional application No. 63/777,054, filed on Mar. 25, 2025.

(51) Int. Cl. C25B 1/04; B01D 53/32; C25B 1/50; C25B 9/19; C25B 11/052; C25B 11/075; C25B 15/08

(52) U.S. Cl. CPC C25B 1/04; B01D 53/326; C25B 1/50; C25B 9/19; C25B 11/052; C25B 11/075; C25B 15/08; B01D 2257/504

(57) ABSTRACT

The disclosed technology relates to electrochemical systems and methods for the energy-efficient generation of base and acid solutions and deionization of saline waters. Various systems and methods include hydrogen pump cells, capacitive-faradaic hybrid cells, and/or zinc redox-based cells. These methods strategically utilize membranes, hydrogen evolution and oxidation reactions, charge storage materials, and redox-active metals to maximize energy efficiency for base and acid generation. Various embodiments enable simultaneous base/acid generation alongside energy storage/conversion, enabling continuous operation of an external device (e.g., a base/acid generating process) during periods of intermittency in renewable energy. Various implementations involve integration with carbon dioxide capture systems and other chemical systems and processes.

### CROSS-REFERENCE TO RELATED APPLICATIONS

This application claims the benefit under 35 U.S.C. § 119(e) of U.S. Provisional Application No. 63/777,054, filed March 25, 2025, and entitled “DEVICES, SYSTEMS, AND METHODS FOR THE ELECTROCHEMICAL GENERATION OF BASE/ACID AND DEIONIZATION OF SALINE WATER,” which is hereby incorporated by reference in its entirety.

### TECHNICAL FIELD

The disclosed technologies relate to the design of devices, systems, and methods for the electrochemical synthesis of base, acid, and the depletion of salt ions from a saline solution.

### BACKGROUND

Acid and base utilization is fundamental to a wide range of chemical processes, including water treatment, chemical synthesis, and pH regulation. An emerging application of base (e.g., alkaline solution) utilization is carbon dioxide (CO₂) capture, where the base serves as a liquid sorbent for CO₂.

Carbon capture technologies are increasingly critical in efforts to mitigate climate change. In particular, alkaline solutions, such as sodium hydroxide (NaOH) or other hydroxide-rich solutions, are effective in absorbing atmospheric CO₂ to form dissolved carbonate or bicarbonate species. However, the large-scale generation of these alkaline solutions is typically energy-intensive, often relying on conventional chlor-alkali processes, electrolytic water splitting, or thermal regeneration methods that require substantial electrical or thermal input and may involve undesirable co-products (e.g., chlorine gas). Furthermore, to maximize net carbon removal it is helpful for such technologies to be powered by renewable energy. However, the intermittency of renewable energy poses practical challenges to ensuring continuous operation.

Given the global need to deploy scalable carbon capture processes, there is a pressing demand for novel, energy-efficient, and cost-effective methods to directly generate base, without co-producing unwanted chemicals or wasting energy. Although electrochemical processes offer a promising route for achieving this goal, conventional approaches suffer from high energy penalties, low selectivity, or complex system requirements.

### SUMMARY

Aspects of the disclosed technology provide novel electrochemical devices, systems, designs, and methods that enable the efficient generation of base (and/or acid) via tailored electrochemical pathways. In various cases, implementations are designed to minimize energy consumption, enhance current utilization (e.g., current efficiency) for base generation, and/or avoid unwanted by-products, thereby offering more sustainable and practical approaches to producing alkaline solutions for carbon capture and other industrial applications. Various implementations incorporate capacitive energy storage and/or hydrogen production and storage, allowing for stored energy to be converted and utilized during periods of intermittency in renewable energy supply.

Various aspects of the disclosed technology provide novel electrochemical systems and methods for the efficient and scalable generation of acid and base, which in various cases are designed to minimize energy input and/or avoid undesirable by-products. Implementations of the technology encompass various electrochemical configurations, including continuous and cyclic processes that use hydrogen electrochemistry and innovative cell architectures to achieve enhanced energy efficiency and operational flexibility. Various implementations include electrochemical methods of acid/base generation which are expected to operate near the thermodynamic limits of maintaining pH gradients through the minimization of internal cell resistances, overpotentials, and/or parasitic currents.

One aspect of the disclosed technology provides an electrochemical system with a multi-compartment (e.g., three-compartment) hydrogen looping electrochemical cell. In various cases the cell has channels for acid, base, and an input liquid, separated by ion-exchange membranes. In various cases the input liquid is saltwater or saline solution of varying salinity. The electrochemical system can operate continuously, employing the hydrogen evolution reaction (HER) at the cathode and the hydrogen oxidation reaction (HOR) at the anode. Hydrogen gas generated at the cathode is delivered to the anode to close the redox cycle and enable continuous acid and base production from the input liquid (e.g., saline feed).

According to various implementations, ion-exchange membranes or coatings may be placed adjacent to the electrodes (i.e., in direct contact with the electrodes) to optimize performance by minimizing local pH gradients and potentially avoiding undesired side-reactions. Alternatively, these membranes or coatings may be omitted if electrode pH gradients, overpotentials, or competing reactions are not limiting factors. According to various cases, a three-compartment design enables the production of relatively concentrated acid and base products with minimal current efficiency loss. In some cases periodic polarity reversal may be employed to mitigate the scaling of the electrode during HER. This can enhance long-term operational stability and allow for lower-quality input liquids to be fed to the system.

Another aspect of the disclosed technology provides an electrochemical system with a capacitive charging cell operating in a cyclic manner to generate base during the charging step and acid during the discharging step. In various implementations, the system can employ a single-channel design (e.g., membrane-less) or a multi-compartment design (e.g., utilizing ion-exchange membranes). During a capacitive electrode charging phase, HER at a cathode produces hydrogen gas and hydroxide ions, while anions (e.g., chloride) are removed from solution and stored in the capacitive anode. During this operation, no acid is generated, simplifying hydroxide product separation and maximizing current efficiency. Furthermore, the potential for removal of membranes from the system minimizes internal cell resistance. Activated carbon materials, pseudocapacitive materials (e.g., Prussian blue analogs, graphene, metal organic frameworks), battery electrodes, and other high-capacity electrodes may be employed to facilitate charge storage and ion removal. After reaching a defined state of charge, the system can be discharged passively (or with a small applied potential) to recover the energy stored in the capacitive electrode (i.e., which was expended towards capacitive electrode charging). During discharging, the previous cathode can operate to generate acid via oxygen evolution reaction (OER) or via HOR in cases where previously generated hydrogen is fed to the electrode and energy stored in the hydrogen is utilized, lowering or eliminating the need for energy input during discharge of the capacitive electrode. The energy recovered during discharging may be utilized to power an external load, such as another acid/base generating device, thereby enabling continuous base (e.g., carbon capture solvent) generation. In various cases, polarity reversal can be used to mitigate scaling at the HER electrode.

Another aspect of the disclosed technology provides an electrochemical system that employs a zinc redox-based cyclic cell to generate acid and base according to various implementations. Zinc redox chemistry provides low overpotentials, hence its widespread se in battery technologies. When the zinc electrode serves as the anode, zinc metal is oxidized forming zinc ions in solution, while HER simultaneously occurs at the cathode, generating hydrogen gas and a hydroxide-rich solution. In various cases the cell system includes at least two compartments separated by ion-exchange membranes, with a basic cathode compartment (producing NaOH) and an acidic zinc-containing anode loop (i.e., anolyte). In some cases zinc anode replating may periodically be required for continued use of the zinc electrode. Specifically, the polarity of the electrodes can be reversed, during which zinc ions in the anolyte will be reduced and redeposited onto the electrode. Simultaneously, either OER or HOR (if previously produced hydrogen is fed to the electrode) will occur at the anode, generating an acid product. In various implementations the utilization of hydrogen at the anode will reduce required energy input. Polarity reversal may also be exploited to minimize fouling and scaling of the electrodes. Alternatively, the zinc electrode may be sacrificial (and be periodically replaced), in which case no electrode regeneration step would be required, energy would be saved, and previously produced hydrogen gas would be retained. In various cases a three-compartment version may be implemented, introducing a central desalination channel for simultaneous salt ions removal.

Various aspects of the described technology offer several advantages over existing technologies. Advantages include energy-efficient generation of base and acid, with simultaneous deionization of a saline water, without chlorine gas production or other undesirable by-products; closed-loop hydrogen gas generation and use of generated hydrogen gas, either in a continuous or periodic manner; the capability to generate base and liberate pure CO₂from carbonate or bicarbonate ions using a single system; and flexibility for continuous, batch, or semi-batch operation to suit different industrial applications, including carbon capture.

Additional advantages over existing technologies include mitigation of electrode and membrane scaling and fouling through periodic polarity reversal or electrode regeneration; the capability to generate base during charging of a capacitor and simultaneous hydrogen generation; the potential for integrated energy storage and recovery via a capacitive half-cell and stored hydrogen; the potential to provide power to an external load (e.g., another acid/base generation device) during periods of intermittency in renewable power; the option to operate with a sacrificial anode, thus minimizing total energy input for base generation; and elimination or reduction of membrane costs through optional membrane-less configurations in certain embodiments.

Implementations of the disclosed technology represent a significant advance in the field of electrochemical acid and base generation, particularly for applications such as carbon capture, brine management, and industrial pH management, where low energy input and high system durability can be important.

Implementations of the disclosed technology and described examples may include the use of hardware, a method or process, or computer software on a computer-accessible medium. Various implementations include a system of one or more computers or automated systems that can be configured to perform particular operations or actions by virtue of having software, firmware, hardware, or a combination of them installed on the system that in operation causes or cause the system to perform the actions. As an example, various implementations may include a control system with one or more computers or processing circuitry configured to carry out one or more parts of a method for generating acid and base with an electrochemical system by controlling various hardware, including for example, pumps, valves, compressors, and the like. One or more computer programs can be configured to perform particular operations or actions by virtue of including instructions that, when executed by data processing apparatus, cause the apparatus to perform the actions.

An aspect of the disclosed technology includes an electrochemical system for generating acid and base solutions while simultaneously deionizing a saline or brine feed solution. The system includes an anode compartment comprising an anode configured to perform a hydrogen oxidation reaction, a cathode compartment comprising a cathode configured to perform a hydrogen evolution reaction, an acid compartment, and a base compartment. The system also includes one or more ion-exchange membranes positioned between the acid compartment and the base compartment, and a hydrogen circulation loop configured to transfer hydrogen gas between the cathode and anode compartments. The system is configured to generate an acidic solution in the acid compartment and a basic solution in the base compartment during operation.

Implementations according to this aspect of the disclosure may include any combination of the following features. In some cases the one or more ion-exchange membranes comprise one or more of a cation-exchange membrane, an anion-exchange membrane, and a bipolar membrane. In some cases the system further comprises multiple brine compartments positioned between the acid compartment and the base compartment, wherein at least one of the ion-exchange membrane is positioned between the acid compartment and the multiple brine compartments, and wherein at least another one of the ion-exchange members is positioned between the base compartment and the multiple brine compartments. In some cases the system further comprises a reverse operational mode in which the polarity of the electrodes is reversed to mitigate scaling and/or fouling. In some cases protons produced in the acid compartment are reacted with carbonate or bicarbonate ions to release carbon dioxide gas, while simultaneously regenerating an alkaline solution. In some cases the cell configuration is duplicated, but two or more anodes share a single central cathode.

Another general aspect of the disclosed technology includes a capacitive charging electrochemical system for generating acid and base solutions from a saline or brine feed. The system includes a capacitive electrode configured to sorb anions from the feed solution during charging, a cathode configured to perform a hydrogen evolution reaction (HER) to generate a basic solution and hydrogen gas during charging, a charge/discharge control system (e.g., control circuitry) configured to alternately charge and discharge the capacitive electrode, and an anode configured to perform a hydrogen oxidation reaction (HOR) or oxygen evolution reaction (OER) during discharge, wherein acid is generated during discharge.

Implementations according to this aspect of the disclosure may include any combination of the following features. In some cases the capacitive electrode comprises an activated carbon, battery electrode, intercalation electrode, or a pseudocapacitive material. In some cases the system operates without ion-exchange membranes during charging and discharging. In some cases a base is generated during the charging phase of the capacitive electrode. In some cases hydrogen is generated during the charging phase of the capacitive electrode. In some cases energy stored during the charging phase, in the capacitive electrode and/or generated/stored hydrogen is partially or fully recovered during discharging. In some cases the energy stored in the capacitor and/or hydrogen (stored during charging) is utilized to power an external load (e.g., an external acid/base generation device). In some cases the energy stored in the capacitor and/or hydrogen (stored during charging) is utilized to supply energy during periods of intermittency in renewable energy supply. In some cases hydrogen generated during charging is directed to the anode during discharging to perform a hydrogen oxidation reaction. In some cases protons produced during discharging are reacted with carbonate or bicarbonate ions to release a pure carbon dioxide gaseous product. In some cases the system also includes a reverse operational mode in which the polarity of the electrodes is reversed to mitigate scaling or fouling.

Another general aspect of the disclosed technology includes a zinc redox electrochemical system for generating acid and base solutions from a saline or brine feed. The system includes an anode configured to oxidize zinc metal to Zn²⁺ ions during a first operational mode, a cathode configured to perform a hydrogen evolution reaction (HER) to generate a basic solution during the first operational mode, a zinc ion solution in contact with the anode, an ion-exchange membrane separating the anode and cathode compartments, and a second operational mode in which the polarity of anode and the cathode is reversed for zinc electrode replating, thereby reducing Zn²⁺ to zinc metal, generating an acid solution, and optionally oxidizing hydrogen or performing oxygen evolution reaction at the anode.

Implementations according to this aspect of the disclosure may include one or more of the following features. In some cases the system also includes a brine compartment positioned between the anode and cathode compartments and separated from each by ion-exchange membranes. In some cases zinc metal is regenerated in the anode compartment during discharge via reduction of Zn²⁺ ions. In some cases hydrogen generated during charging is directed to the anode and utilized during discharging to perform a hydrogen oxidation reaction. In some cases protons produced during discharging are reacted with carbonate or bicarbonate ions to release a pure carbon dioxide gaseous product. In some cases second operational mode is performed to mitigate scaling or fouling.

Another general aspect of the disclosed technology includes an atmospheric carbon dioxide removal process. The process includes one or more electrochemical systems. In some cases the process uses an electrochemical system for generating acid and base solutions while simultaneously deionizing a saline or brine feed solution. The system includes an anode compartment comprising an anode configured to perform a hydrogen oxidation reaction, a cathode compartment comprising a cathode configured to perform a hydrogen evolution reaction, an acid compartment, and a base compartment. The system also includes one or more ion-exchange membranes positioned between the acid compartment and the base compartment, and a hydrogen circulation loop configured to transfer hydrogen gas between the cathode and anode compartments. The system is configured to generate an acidic solution in the acid compartment and a basic solution in the base compartment during operation.

In some cases the process uses a capacitive charging electrochemical system for generating acid and base solutions from a saline or brine feed. The system includes a capacitive electrode configured to sorb anions from the feed solution during charging, a cathode configured to perform a hydrogen evolution reaction (HER) to generate a basic solution and hydrogen gas during charging, a charge/discharge control system (e.g., control circuit) configured to alternately charge and discharge the capacitive electrode, and an anode configured to perform a hydrogen oxidation reaction (HOR) or oxygen evolution reaction (OER) during discharge, wherein acid is generated during discharge.

In some cases the process uses a zinc redox electrochemical system for generating acid and base solutions from a saline or brine feed. The system includes an anode configured to oxidize zinc metal to Zn²⁺ ions during a first operational mode, a cathode configured to perform a hydrogen evolution reaction (HER) to generate a basic solution during the first operational mode, a zinc ion solution in contact with the anode, an ion-exchange membrane separating the anode and cathode compartments, and a second operational mode in which the polarity of anode and the cathode is reversed for zinc electrode replating, thereby reducing Zn²⁺ to zinc metal, generating an acid solution, and optionally oxidizing hydrogen or performing oxygen evolution reaction at the anode.

Another general aspect of the disclosed technology includes a carbon capture process using a capacitive charging electrochemical system for generating acid and base solutions from a saline or brine feed. The system includes a capacitive electrode configured to sorb anions from the feed solution during charging, a cathode configured to perform a hydrogen evolution reaction (HER) to generate a basic solution and hydrogen gas during charging, a charge/discharge control system (e.g., control circuitry) configured to alternately charge and discharge the capacitive electrode, and an anode configured to perform a hydrogen oxidation reaction (HOR) or oxygen evolution reaction (OER) during discharge, wherein acid is generated during discharge. During periods of intermittency in renewable power, the capacitive cell is discharged to provide power to an alternative method of base generation, thereby sustaining continuous base generation.

While multiple embodiments are disclosed, still other embodiments of the disclosure will become apparent to those skilled in the art from the following detailed description, which shows and describes illustrative embodiments of the disclosed apparatus, systems, and methods. As will be realized, the disclosed apparatus, systems, and methods are capable of modifications in various obvious aspects, all without departing from the spirit and scope of the disclosure. Accordingly, the drawings and detailed description are to be regarded as illustrative in nature and not restrictive

### BRIEF DESCRIPTION OF THE DRAWINGS

FIG. 1 is a schematic illustration of an electrochemical system with an electrochemical cell and hydrogen loop according to one implementation.

FIG. 2 is a schematic illustration of an electrochemical system with an electrochemical cell and hydrogen loop according to one implementation.

FIG. 3 is a schematic illustration of an electrochemical system with an electrochemical multi-cell design with two hydrogen loops according to one implementation.

FIG. 4 is a schematic illustration of an electrochemical system with an electrochemical multi-cell design with one hydrogen loop according to one implementation.

FIG. 5A is a schematic illustration of a capacitive charging electrochemical system during a charge operation according to one implementation.

FIG. 5B is a schematic illustration of the capacitive charging electrochemical system of FIG. 5A during a discharge operation according to one implementation.

FIG. 6A is a schematic illustration of a metal redox-based electrochemical system during a base generation operation according to one implementation.

FIG. 6B is a schematic illustration of the metal redox-based electrochemical system of FIG. 6A during a metal replating operation according to one implementation.

FIG. 7 is a flow diagram of a carbon capture process incorporating an electrochemical system according to one implementation.

FIG. 8A is a flow diagram of a carbon capture process using a renewable energy source according to one implementation.

FIG. 8B is a flow diagram of the carbon capture process of FIG. 8A using a capacitive electrochemical system to generate power according to one implementation.

FIG. 9 is a perspective view of an assembled bench-scale electrochemical system according to one implementation.

FIG. 10 is a schematic illustration depicting a hydrogen loop of the electrochemical system of FIG. 9 according to one implementation.

FIG. 11 is a graph of linear sweep voltammetry profiles of the electrochemical system of FIG. 9 according to one implementation.

FIG. 12 is a graph of cell potential over time for the electrochemical system of FIG. 9 according to one implementation.

FIG. 13 is a graph depicting steady-state cell potentials for various electrodes according to one implementation.

### DETAILED DESCRIPTION

Implementations of the disclosed technology involve electrochemical devices, systems and methods for the generation of acid and base streams from input liquids such as saline solutions with improved energy efficiency, flexibility, and operational tunability. In particular, various electrochemical systems are disclosed that enable acid and base generation through hydrogen-based electrochemical reactions, capacitive charging processes, and/or metal oxidation-reduction cycling. Examples of electrochemical systems are described in detail below with reference to the accompanying figures, which illustrate the architecture and function of each example.

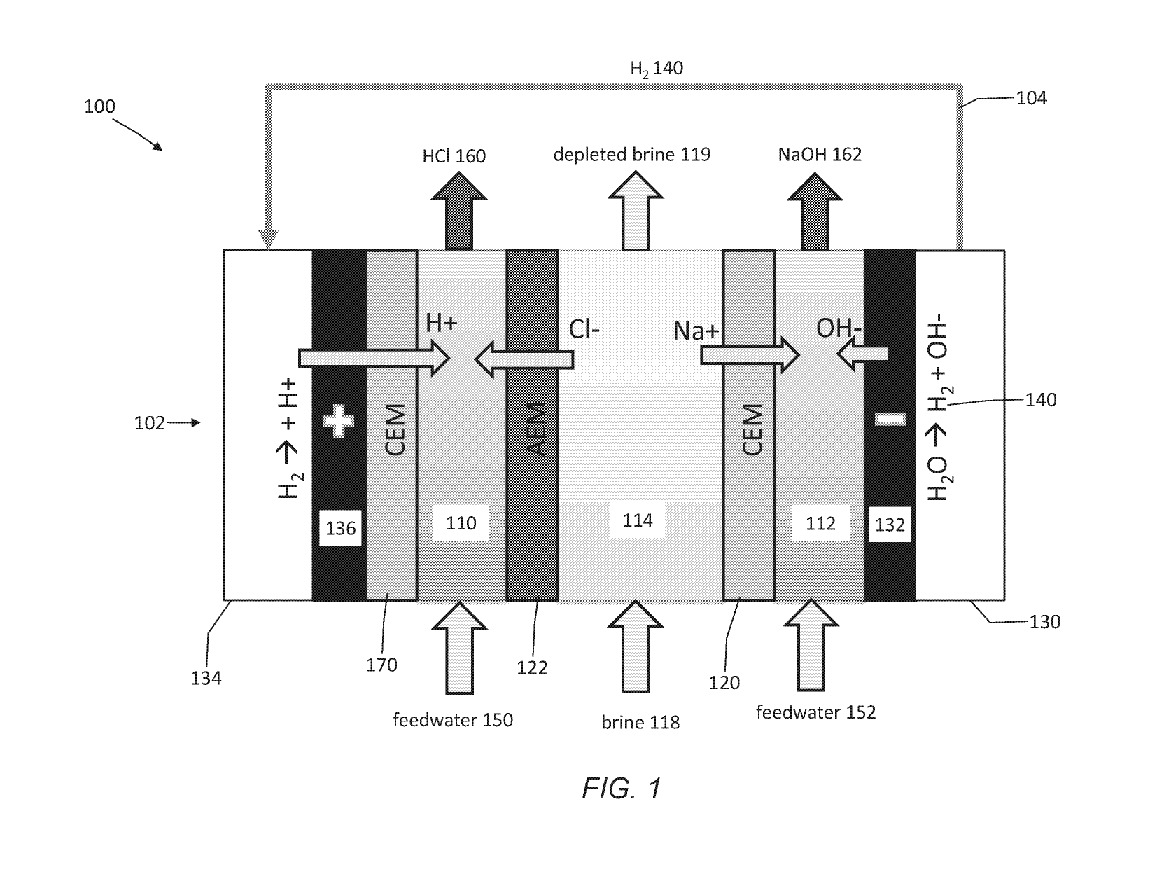

Turning to FIG. 1, an electrochemical system 100 with an electrochemical cell 102 and hydrogen loop 104 is schematically depicted according to various implementations. In various cases, the system 100 may also be referred to as the hydrogen pump electrochemical system 100. According to this example, the electrochemical cell 102 has a three-compartment cell configuration with a distinct acid channel or compartment 110, a base channel 112, and an input liquid channel 114. In various implementations the input liquid is brine 118 as shown in the example in FIG. 1. In this example the channels 110, 112, and 114 are separated by ion-exchange membranes, including a cation-exchange membrane 120 (CEM) and an anion-exchange membrane 122 (AEM). Other configurations, including with bipolar membranes (BPM), may be used depending on the desired operation.

The system 100 comprises a cathode compartment 130 with a cathode 132 where hydrogen evolution reaction (HER) occurs and an anode compartment 134 with an anode 136 where hydrogen oxidation reaction (HOR) takes place. During a first operational mode or phase, hydrogen gas 140 is continuously generated at the cathode 132 and directed through the hydrogen circulation loop 104 to the anode compartment 134 where it is consumed. The flow of hydrogen gas enables a continuous operation that generates protons in the acid compartment 110 and hydroxides in the base compartment 112, while simultaneously depleting salt ions from the brine 118 in the input liquid channel 114. Accordingly, in various implementations the input liquid channel 114 may also be referred to as a desalination compartment.

In various implementations, the input liquid or feedwater to the input liquid channel 114 is brine 118 that primarily includes salt ions (e.g., sodium chloride). The salt ions are removed from the channel 114 during operation (i.e., deionizing the brine) and are utilized to produce the acid (e.g., HCl) and base (e.g. NaOH) products. A feedwater 150 for the acid channel 110 may or may not be saltwater or saline and may be of varying composition. Similarly, a feedwater 152 such as, for example, saline, which may or may not be the same as the acid channel feedwater 150, is fed to the base compartment 112. In various cases these feedwaters 150, 152 may or may not be recirculated through the channels to generate more concentrated acid product 160 and base product 162, respectively. In the central input liquid channel 114, a feed brine 118, which may be of varying salinity, is provided. In various implementations the input liquid (e.g., brine 118) may or may not be recirculated through the input liquid channel 114 to achieve a desired depleted concentration (e.g., depleted brine 119).

Optionally, an ion-exchange membrane may be placed in direct contact with one or more of the electrodes to minimize pH gradients at the electrode surfaces, minimize electrode overpotentials, minimize wetting or flooding of electrodes, and to avoid undesired side reactions. In the example shown in FIG. 1, a cation-exchange membrane 170 (CEM) (e.g., Nafion, proton-exchange membrane, microporous polymer, ceramic membrane) is directly adjacent to and contacting the anode 136 to conduct the generated protons to the acid channel, minimize buildup of protons at the anode, and minimize exposure of the anode to water. In variations where electrode overpotentials, pH gradients, or competing reactions are not limiting, the membranes or coatings adjacent to the electrodes may be omitted to reduce material and assembly complexity as well as reduce internal cell resistance. Furthermore, while FIG. 1 shows a three-compartment design for simultaneous brine deionization and acid/base generation, a varying number of membranes (e.g., as few as one or greater than three) may be utilized between the electrodes to alter the number of flow channels to provide various functionality. The system may also employ a periodic second operational mode or reverse operational mode in which the polarity of the electrodes is reversed to mitigate scaling and fouling incurred on the electrodes during operation, thereby enhancing long-term stability and performance. For example, a control system operating the electrochemical system 100 may reverse the polarity of power feeding the cathode and anode. The control system may include, for example, processing circuitry and/or one or more computers configured to control the electrochemical system 100 to generate acid and base by operating pumps, valves, compressors, an MFC, and other components of the system 100.

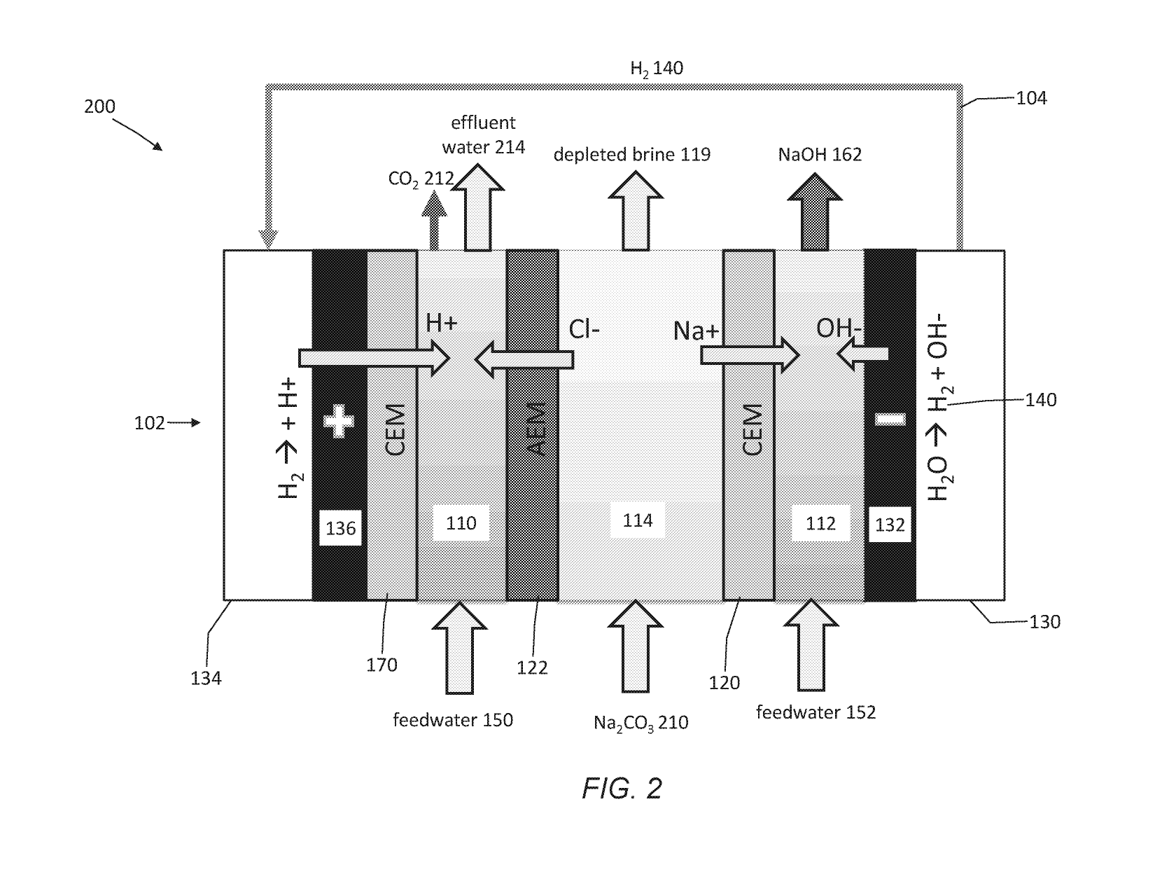

According to various implementations, the protons generated in the electrochemical cell 102 can be used to regenerate an alkaline CO₂ capture solvent and liberate a pure CO₂ product stream, in addition to generating acid and base products. Turning to FIG. 2, for example, an electrochemical system 200 uses a carbonate solution 210 as the input liquid instead of brine. in FIG. The carbonate solution 210, which may or may not also contain bicarbonates and other constituents, may be directed as the input liquid or feed solution into the input liquid channel/compartment 114. In various cases, the carbonate solution 210 is formed via a direct air capture (DAC) process where CO₂ is reacted with an alkaline solvent. Carbonate/bicarbonate ions are transported under the electric field to the acid channel 110, where they react with generated protons, thereby releasing a concentrated stream of pure CO₂ gas 212. The CO₂gas 212 may in some cases be used downstream or sequestered. The effluent water 214 from the acid channel may or may not be recirculated through the channel, may or may not contain residual carbonate or bicarbonate ions, and may be of varying pH. During operation, cations (e.g., sodium ions) are transported from the carbonate feed solution 210 to the base channel 112, thus generating a hydroxide rich solution 162 (e.g., NaOH) which may be used as a carbon capture solvent.

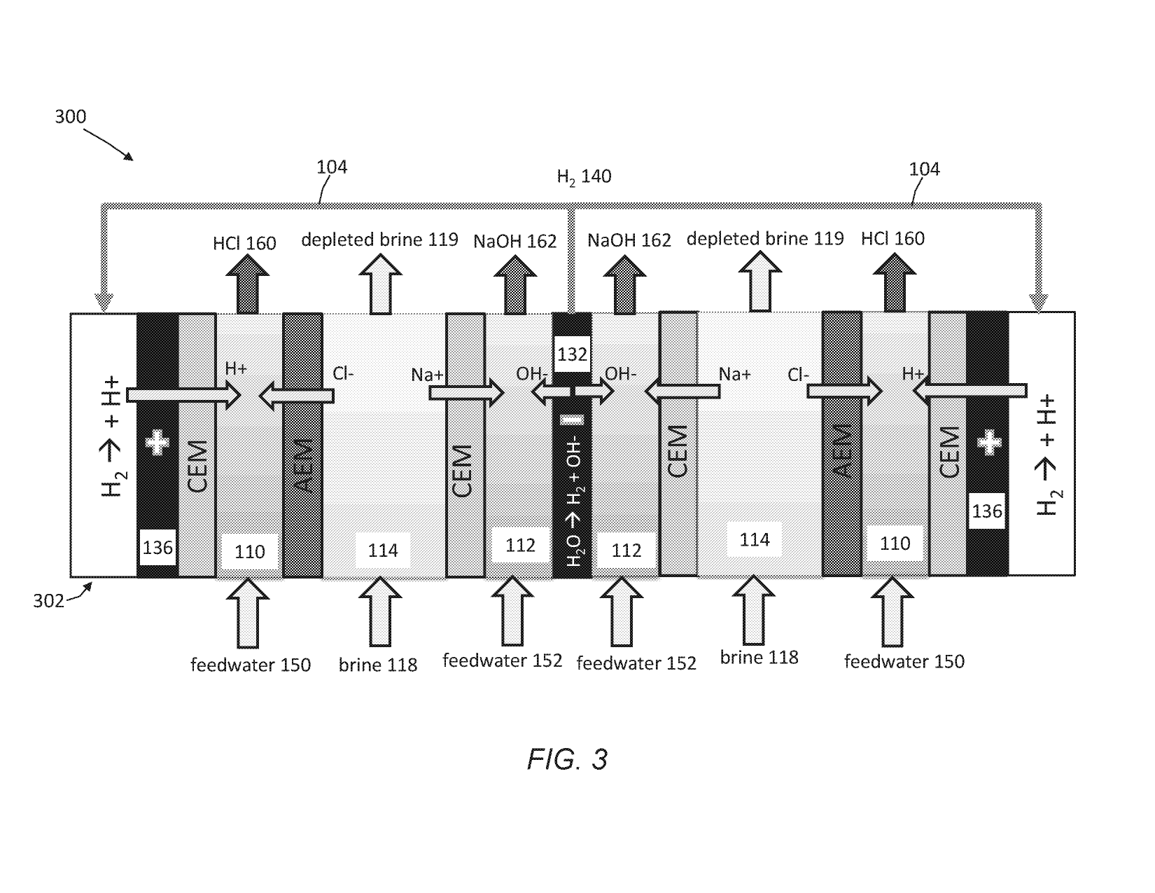

FIG. 3 illustrates an electrochemical system 300 with an electrochemical multi-cell design with two hydrogen loops 104 according to various implementations. In this example, the system 300 includes an extended version of the cell design illustrated in FIG. 1 such that a single cathode 132 is electrically connected to two anodes 136. The current handled by the cathode 132 is the sum of the currents at the individual anodes 136. In various cases the resulting hydrogen 140 produced from the cathode is distributed to the anodes 136 in proportion to their respective current, thus enabling continuous operation. As an example, in some cases the current and generated hydrogen is evenly split among the two anodes 136, while in other cases the distribution of current and hydrogen may be asymmetric. The total current may be readily distributed across the anodes by using each anode as a working electrode, while the cathode serves as the counter-electrode. Hydrogen gas flow to each anode can be actively controlled by using mass-flow controllers, ensuring precise distribution of the hydrogen to each anode.

Each of the fluid flow streams depicted in FIG. 3 are the same as those presented in FIG. 1. According to various implementations, a carbonate solution (which may or may not consist of a mixture of carbonates and bicarbonates along with other constituents) may serve as the input liquid in place of the brine 118, resulting in the same flows depicted in the system 200 of FIG. 2. Turning back to FIG. 3, the stack design for the electrochemical cell 302 provides an option for scaling the concept presented in FIG. 1, whereby minimal electrode material is used, as opposed to construction of two separate stacks with four total electrodes (i.e., two cathodes and two anodes). Additional implementations, not explicitly shown in FIG. 3, may include systems where more than two anodes are connected to a single cathode.

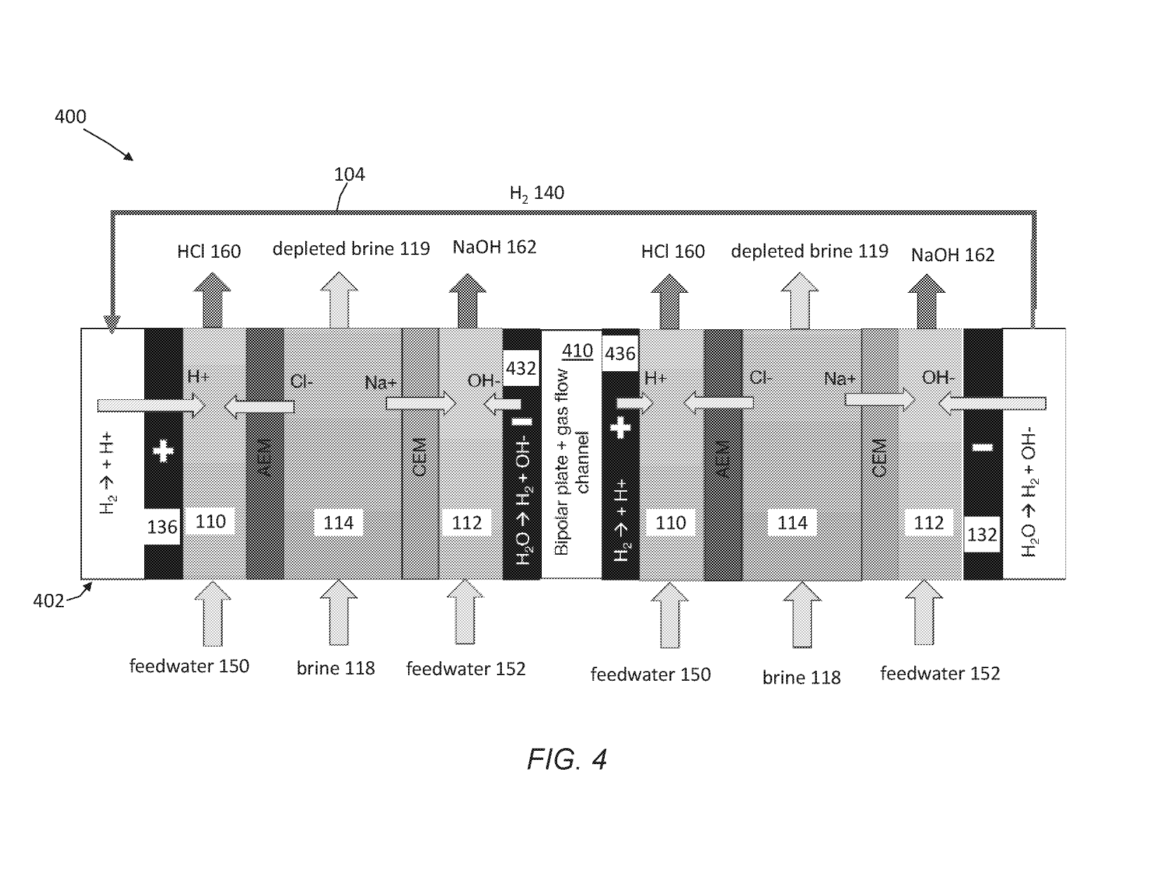

FIG. 4 is a schematic illustration of an electrochemical system 400 according to various implementations. The system 400 includes an electrochemical cell 402 with a multi-cell design and one hydrogen loop 104 according to various implementations. The cell design builds upon the multi-anode/single-cathode stack configuration for the cell 302 shown in FIG. 3. According to various implementations, the novel, highly scalable cell architecture concept of FIG. 4 eliminates the need for an external hydrogen looping structure for internal cells. Instead, bipolar plates (BPPs) 410 are utilized to bridge adjacent cell pairs. During operation, each bipolar plate 410 sits at a specific electrical potential, allowing it to serve simultaneously as the cathode potential for one cell pair and the anode potential for the adjacent cell pair. A single electrical potential is applied across the entire terminal stack, and the voltage distributes naturally across the internal cell pairs.

According to various implementations, hydrogen advantageously flows directly through the bipolar plates 410. For example, hydrogen gas (H2) generated at the cathode 432 of one cell is directly shuttled through the plate 410 into the anode 436 of the adjacent cell to perform the Hydrogen Oxidation Reaction (HOR). Because the hydrogen is routed internally between adjacent cells, no external hydrogen loop plumbing is required for the internal stack. A remaining hydrogen circulation loop 104 bridges the terminal electrodes of the cell 402 to complete the hydrogen loop. In various cases, integrated manifolds are utilized to supply and distribute the necessary hydrogen to each cell pair and bipolar plate, resulting in a highly compact, efficient, and scalable continuous operation.

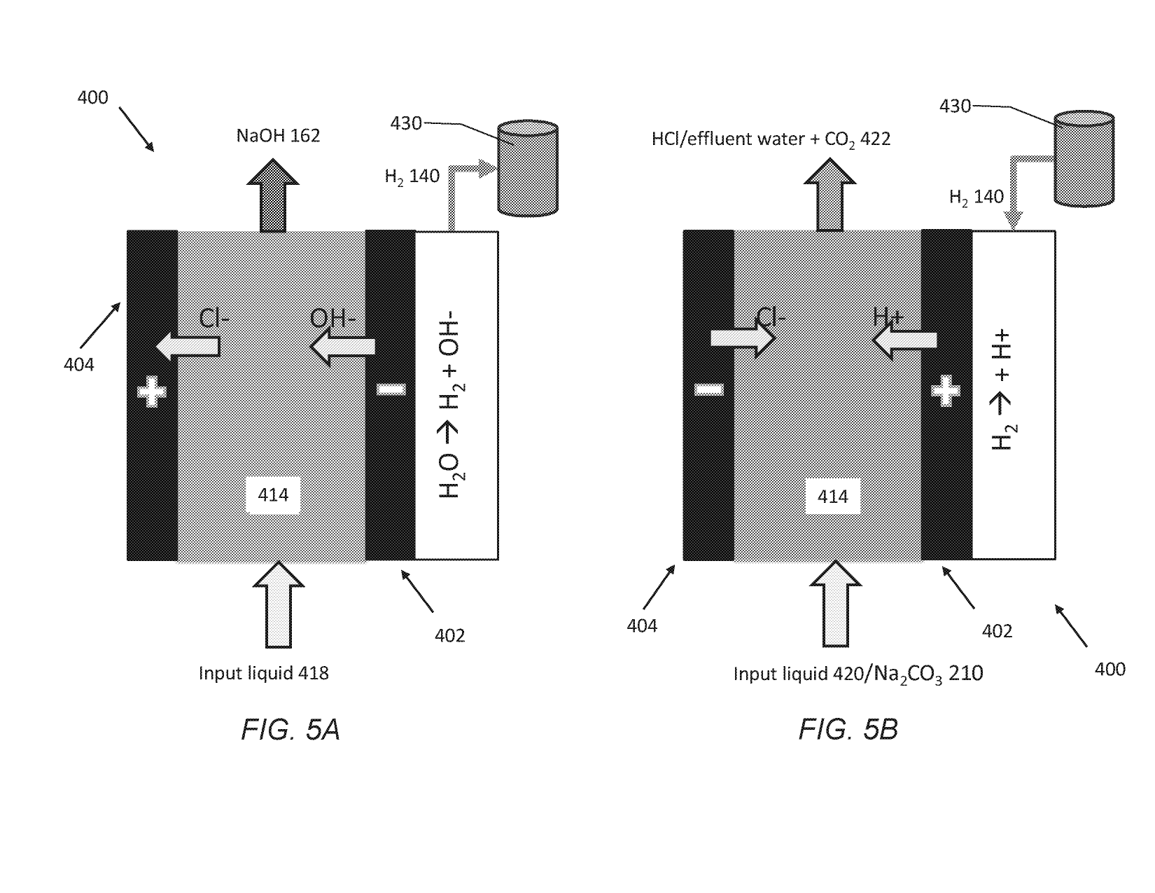

FIGS. 5A and 5B are schematic illustrations of a hybrid capacitive and faradaic electrochemical system 400 for cyclic generation of acid and base according to various implementations. The system features a cathode that performs hydrogen evolution reaction (HER) during a charging step shown in FIG. 5A, generating hydrogen gas and hydroxide-rich solution (base). The system also includes a capacitive/pseudocapacitive electrode (e.g., activated carbon or Prussian Blue Analogue) that stores anions such as chloride. During the discharge step shown in FIG. 5B, acid is generated via the oxygen evolution (OER) or hydrogen oxidation reaction (HOR). Optional hydrogen feeding for HOR is illustrated to enhance overall energy efficiency. The figures highlight the cyclic charge/discharge steps. Membranes may also be incorporated to add additional compartments and functionality.

In various implementations, the system 400 shown in FIGS. 5A-5B operates as a cyclic process and in various cases may include only a single-compartment or single-channel 414 design. During the charging phase shown in FIG. 5A, an input liquid 418, which may be of varying salinity and composition, is fed into the channel. For example, the input liquid 418 may be a saline solution or brine. During the charging step, a potential is applied across first and second electrodes 402, 404. The applied potential drives HER at the first electrode 402 (i.e., the cathode during charging), which generates hydrogen gas and hydroxide ions. Simultaneously, anions, such as chloride are sorbed within the second electrode 404, which acts as the capacitive electrode (i.e., anode during charging), notably without concurrent HCl generation. The final products from the charging step are hydrogen gas 140 which may be sent to a storage tank 430, and a hydroxide-rich solution 162 (e.g., NaOH). The final hydroxide-rich product 162 may or may not contain residual salt ions.

Once the capacitive electrode 404 is saturated or reaches a particular potential, the charge may be stored for later utilization by disconnecting the external circuit (i.e., open circuit). As shown in FIG. 5B, discharging of the capacitive electrode 404 may be performed by closing the external circuit (i.e., reconnecting the electrodes) and may be performed either passively or accelerated by applying a reverse potential. During discharge, the first electrode 402 (previously acting as the cathode) may act as an anode to perform oxygen evolution reaction (OER). In various cases the hydrogen 140 produced during the charging step may be fed to the first electrode 402 (now anode) to enable HOR, thereby reducing or eliminating the need for energy input. The stored energy (both in the capacitive electrode 404 and in the hydrogen 140 produced/stored during the charging step) may later be leveraged to power external loads, such as external acid/base generating devices. In various cases this stored energy may be utilized to provide energy during periods of intermittency in renewable energy. The input liquid or feedwater 420 to the cell during the discharging may or may not be of varying composition compared to the feedwater 418 during the charging step.

In various cases charging may be referred to as a first operational mode and discharging may be referred to as a second operational mode or a reverse operational mode.

In various cases, during discharging, the feed solution 210 may be a carbonate solution (e.g., from CO₂ capture in alkaline solvent), which may or may not consist of a mixture of carbonate and bicarbonates in addition to other constituents. The protons generated during discharging will react with carbonate ions to liberate gaseous CO₂. Hence the products 422 in this configuration are a pure CO₂ gaseous product and an effluent water, which may or may not consist of residual ions.

The single channel approach shown in FIGS. 5A-5B eliminates the need for ion-exchange membranes, thereby simplifying the system and reducing internal cell resistance. However, variations of the system may incorporate a varying number of ion-exchange membranes or bipolar membranes to add additional compartments; for example, to potentially enhance current efficiency/prevent hydroxide sorption at the capacitive electrode, or to provide additional process functionality. In such embodiments, the feed solution and product compositions may vary. Additionally, ion-exchange membranes or coatings may in some cases directly contact the capacitive electrode to enhance charge efficiency.

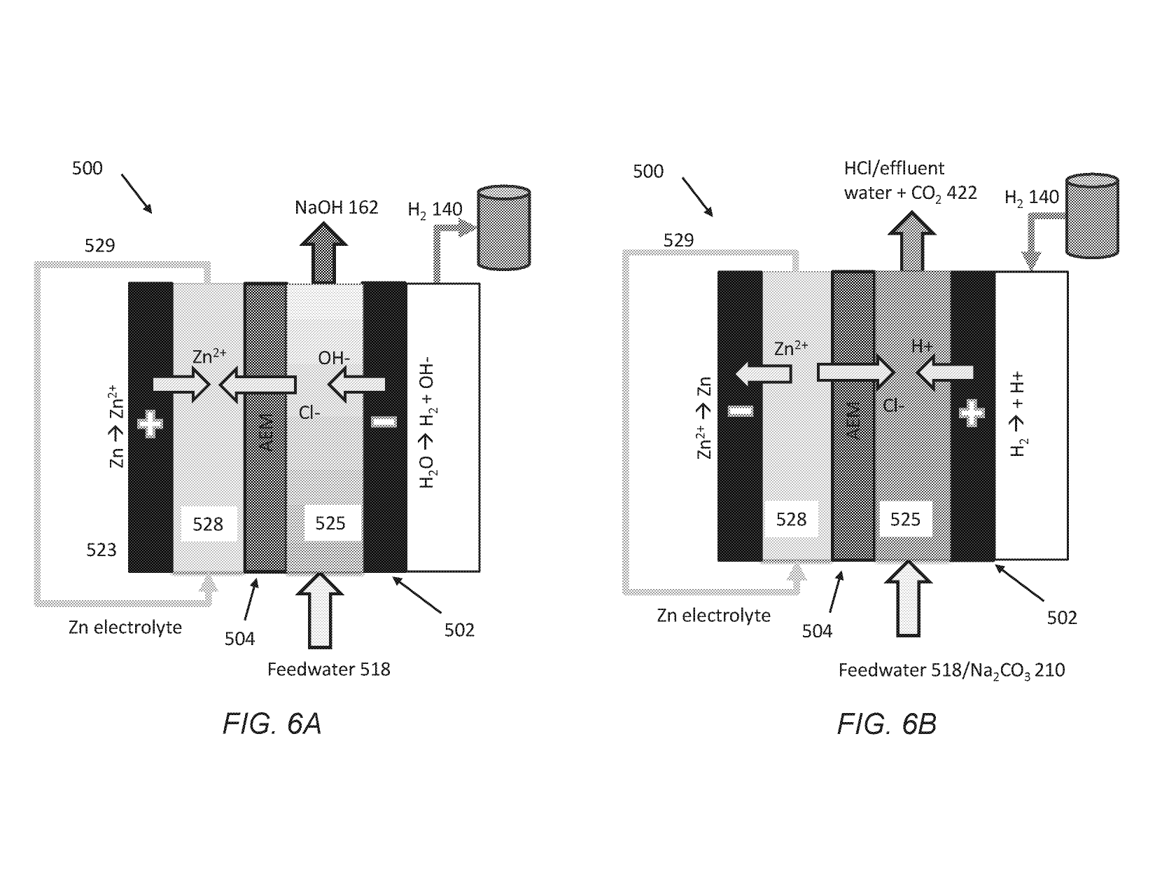

Turning to FIG. 6A, another aspect of the disclosed technology provides a zinc-based electrochemical system 500, operating via a metal redox cycle in a cyclic process according to various implementations. In this system 500, zinc metal oxidation occurs at the anode 523 during a first operational mode or charging phase (converting zinc metal to Zn²⁺ ions), while HER takes place at the cathode 502 to produce hydrogen gas and hydroxide ions. The system 500 comprises at least two compartments: a product compartment 525 where hydroxide rich solvent 162 (e.g., NaOH) is generated along with hydrogen gas 140, and a zinc recirculation compartment 528 containing a zinc salt solution at low pH (to maintain zinc solubility) which is continuously looped through a circulation loop 529 (i.e., anolyte). These compartments are separated by an ion-exchange membrane 504 to maintain the pH and ion gradients necessary for product separation.

In various cases, after a finite period of time, the zinc metal electrode 523 will become depleted of zinc. Turning to FIG. 6B, a reverse polarity step may be performed during a second operational mode to regenerate zinc metal by reduction of Zn²⁺ ions in the recirculating electrolyte 529. For example, a control system operating the electrochemical system 500 may reverse the polarity of power feeding the cathode and anode. During this second operational mode, an input liquid or feedwater 518, which may be of varying composition and salinity, is fed to the product compartment 525. The adjacent electrode 502 (now anode) undergoes OER (or HOR in the case where previously generated hydrogen 140 is fed and utilized). Hence, protons are generated, leading to an acidic product 422 (e.g., HCl). The polarity reversal during zinc replating operation may also be leveraged for scaling mitigation and removal.

As with previous implementations, the input liquid may be a carbonate solution 210 (e.g., from CO₂ capture in alkaline solvent), which may or may not consist of a mixture of carbonate and bicarbonates and other constituents. By feeding this carbonate solution during the zinc replating process, the protons generated at the anode will react with carbonate ions to liberate gaseous CO₂. Hence the products 422 in this configuration are a pure CO₂ gaseous product and an effluent water, which may or may not consist of residual ions.

Various implementations provide an alternative operation mode. In this case, the zinc electrode 23 may not be replated and may serve as a sacrificial anode, to be periodically replaced with a fresh zinc electrode. This operation mode would reduce energy input and result in only a hydroxide-rich product being produced overall (i.e., no acid generation).

Optionally, a third compartment (e.g., such as the brine channel 114 in FIGS. 1-3) may be included between the anode and cathode to enable brine desalination, separated by additional ion-exchange membranes. Additional compartments may also be added for further functionality.

It will be appreciated that implementations of the disclosed technology, including the electrochemical systems and examples discussed herein with respect to the figures, and otherwise, provide distinct pathways for producing acid and base solutions from various feedwaters, including saline feeds, with options to tailor system designs for continuous, batch, or semi-batch operation. Additional variations and combinations of these configurations are envisioned within the scope of the disclosure. As just one example, membranes and electrodes may be functionalized or configured to optimize for specific ion transport, reaction kinetics, or fouling resistance, including the use of advanced ion-exchange membranes, bipolar membranes, or electrode coatings.

Implementations of the disclosed devices, systems and methods can be combined or otherwise utilized with other examples herein. In various cases the teachings of one or more implementations disclosed herein can apply and be integrated within larger chemical systems and processes. Such systems and processes may include, but are not limited to, direct air carbon capture systems. Some examples of systems and processes that can incorporate aspects of the disclosed technology are discussed in U.S. Patent No. 12,030,016, dated July 9,2024, and entitled “Systems and Methods for Direct Air Carbon Dioxide Capture, U.S. Application No. 18/480,779, filed October 4, 2023, and entitled “Systems and Methods for Integrated Direct Air Carbon Dioxide Capture and Desalination Mineral Recovery,” U.S. Application No. 18/919,246, filed October 17, 2024, and entitled “Systems And Methods For Sequestering Alkaline Carbonates With Captured CO₂,” each of which is hereby incorporated by reference in its entirety. Various implementations can make use of the technologies disclosed in the other examples and aspects, such that the teachings contained herein all relate to variations on the implementations disclosed elsewhere herein. One of skill in the art would readily appreciate that in certain implementations, features or other aspects disclosed in any specific example detailed herein can be combined with additional features outlined in alternate examples, such that the instant disclosure contemplates combining various features for individual applications of the disclosed technology.

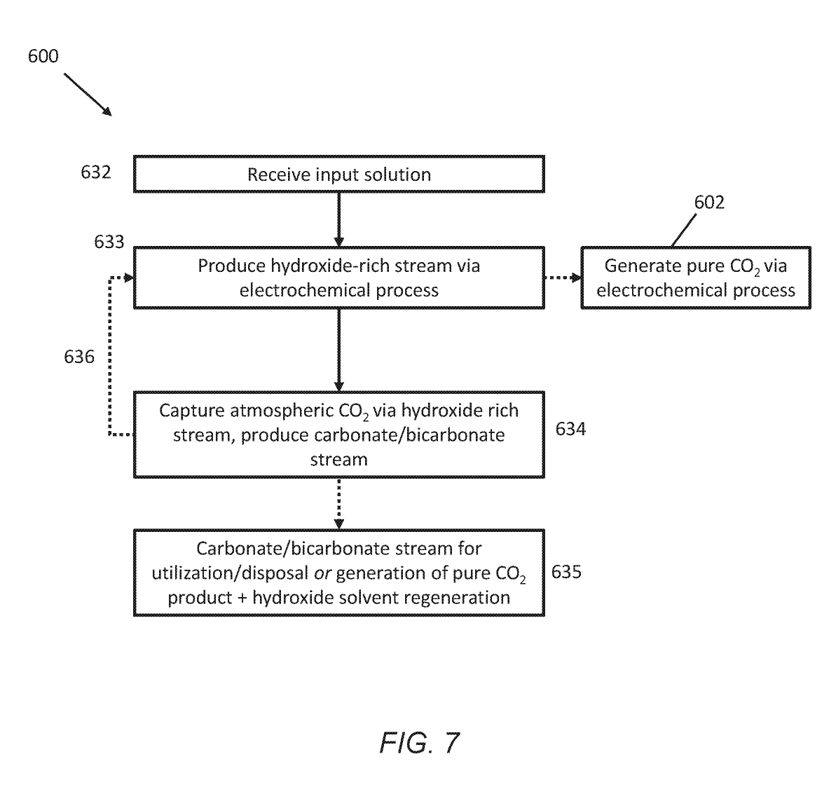

FIG. 7 shows one envisioned example for how implementations of the disclosed technology, including, e.g., any of the electrochemical systems and/or methods described herein, may be integrated into a carbon capture process 600. In this example, the method 600 includes receiving 632 an input solution, which may or may not be saline and which may be of varying composition according to the particular implementation. The input solution is fed to an electrochemical generation system/process to produce 633 a hydroxide-rich solution. The electrochemical generation system and/or process can include any of the base/acid electrochemical generation systems/methods described herein.

The hydroxide-rich solution produced by the electrochemical process is used to capture 634 atmospheric CO₂, and in the process, generate a stream containing carbonates and/or bicarbonates. The carbonate/bicarbonate stream may be utilized or disposed of downstream in various manners 635, including but not limited to sub-surface storage, discharge into aquatic bodies, or precipitation of carbonate-containing products. Alternatively and/or additionally, the carbonate solution may be recirculated 636 to the electrochemical process 633 (or combined externally of the electrochemical process) to generate 602 a pure CO₂ product stream through reacting the carbonates with protons.

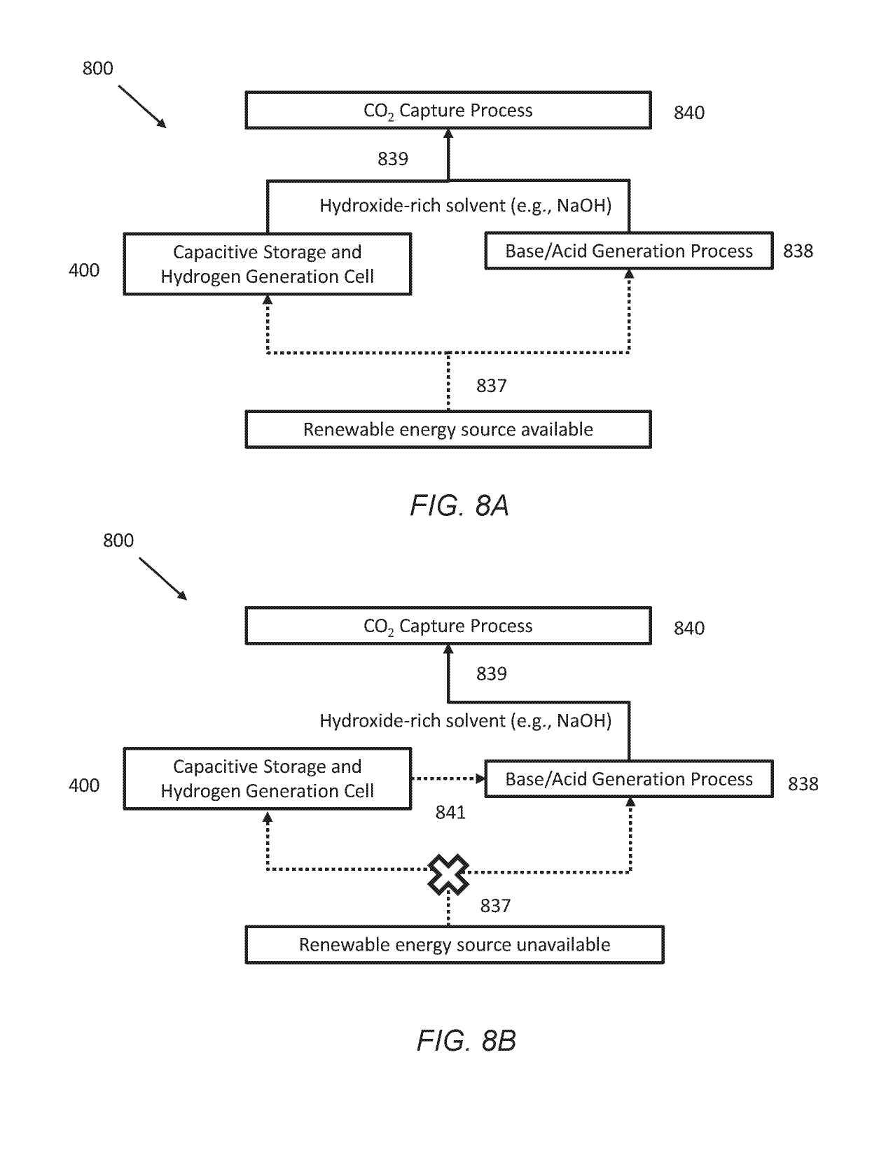

FIGS. 8A-8B illustrate another envisioned process level integration 800 of the disclosed technology, whereby continuous base generation 839 is achieved despite the intermittency of a renewable energy supply. FIG. 8A shows that when renewable power 837 is available, the capacitive storage and hydrogen generation cell 400 shown in FIGS. 5A-5B is charged while generating a hydroxide-rich solvent. In various cases the renewable energy source 837 includes wind, tidal, wave, and/or solar energy. In addition, one or more separate base/acid generation processes 838 (e.g., bipolar electrodialysis) can be simultaneously powered by the renewable power 837, thus producing additional hydroxide-rich solvent. The hydroxide-rich solvent 839 generated from both processes is utilized for atmospheric CO₂ capture 840.

Turning to FIG. 8B, when renewable power 837 is not available, the capacitive storage and hydrogen generation cell 400 is discharged, as described above, generating electric power 841 which is utilized to power the other base/acid generation process 838. Hence, the base generation 839 and carbon capture process 840 can remain continuous throughout periods of renewable energy intermittency.

Although process-level integration of the described systems into larger chemical or carbon capture processes is briefly described in FIG. 7 and FIGS. 8A-8B, these processes only serve as examples, and are not encompassing of all the process configurations which may be employed. Such additional integrations, though not explicitly shown here, are within the scope of the disclosed technology. Examples include, but are not limited to, direct coupling to CO₂ capture units, water treatment facilities, brine treatment plants, and other industrial applications.

### Materials

Those skilled in the art will appreciate that the disclosed examples omit various standard components, features, and details for clarity and brevity, including, for example, various pumps, tanks, pipes, control systems, power systems, and other aspects well-known in the art. Each of the described electrochemical systems can be constructed using commercially available components (e.g., electrodes, compartments, membranes, etc.). In addition, control systems may be implemented with processing circuitry, such as one or more computer processors, configured by hardware and/or software instructions stored in memory to control operation of an electrochemical system. As an example, various implementations may include a control system with one or more computers or processing circuitry configured to carry out a method for generating acid and base with an electrochemical system by controlling electrical power and various hardware, including for example, pumps, valves, compressors, and the like.

Examples of possible electrodes include, but are not limited to, gas diffusion electrodes, metal-based electrodes, carbon-based electrodes, conductive polymers, pseudocapacitive materials, intercalation electrodes, battery electrodes or composites thereof. Electrode materials may include but are not limited to platinum group metals and alloys, earth-abundant metals and alloys, metal nitrides, carbides, and phosphides, activated carbons, carbon nanotubes, graphene derivatives, conductive polymers, transition metal oxides and hydroxides, Prussian blue analogues, and metal-organic frameworks.

Examples of possible membranes include, but are not limited to, cation exchange membranes (CEM), Nafion membranes, anion exchange membranes (AEM), bipolar membranes, ceramic separators, microporous polymers, and metal-organic framework membranes.

The choice of materials may be tailored to specific application needs including, for example, maximizing durability, minimizing cost, and optimizing energy efficiency.

### Example

A bench-scale electrochemical system has been successfully designed, constructed, and tested according to various implementations of the disclosed technology. The electrochemical system, which included an electrochemical cell and a closed hydrogen loop, successfully operated with the Hydrogen Evolution Reaction (HER) at the cathode and the Hydrogen Oxidation Reaction (HOR) at the anode of the cell. Experimental data demonstrates that using the closed hydrogen loop in various implementations can significantly minimize cell overpotentials and required energy input compared to traditional water splitting methods.

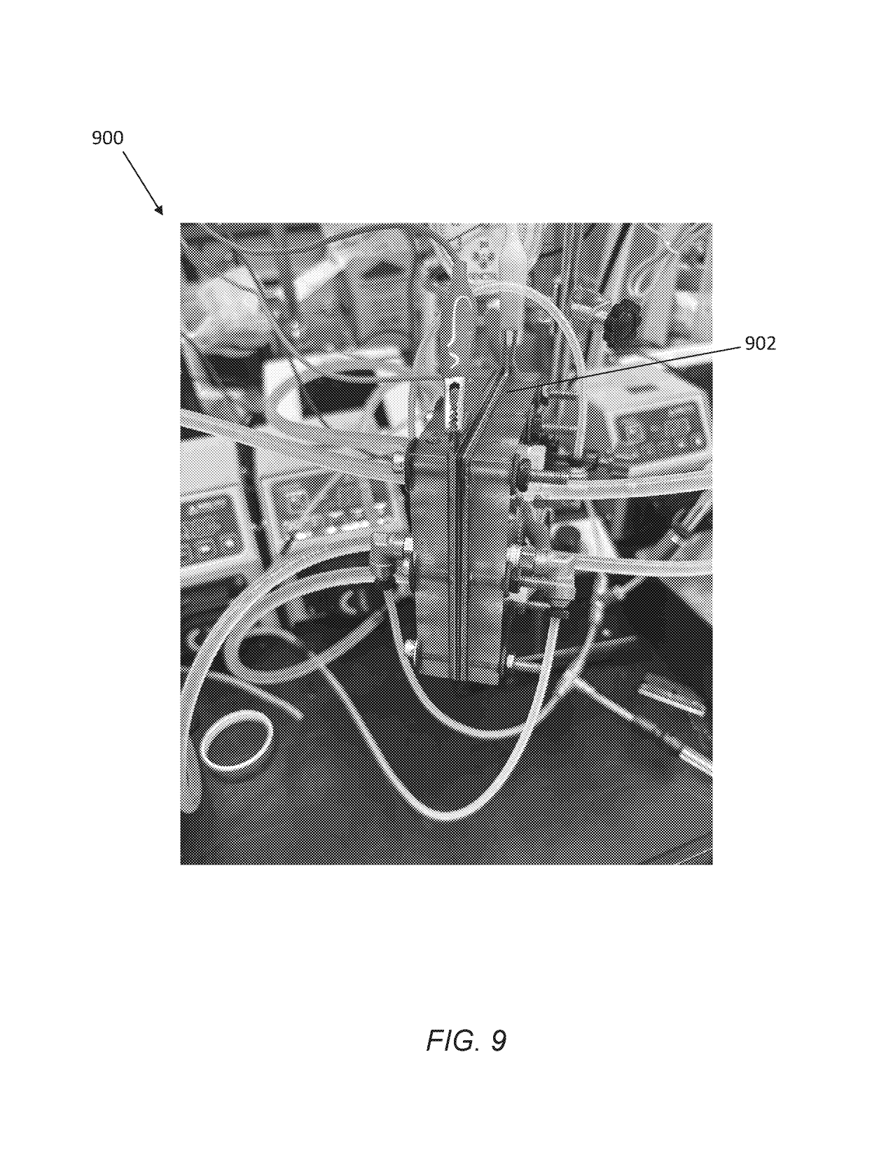

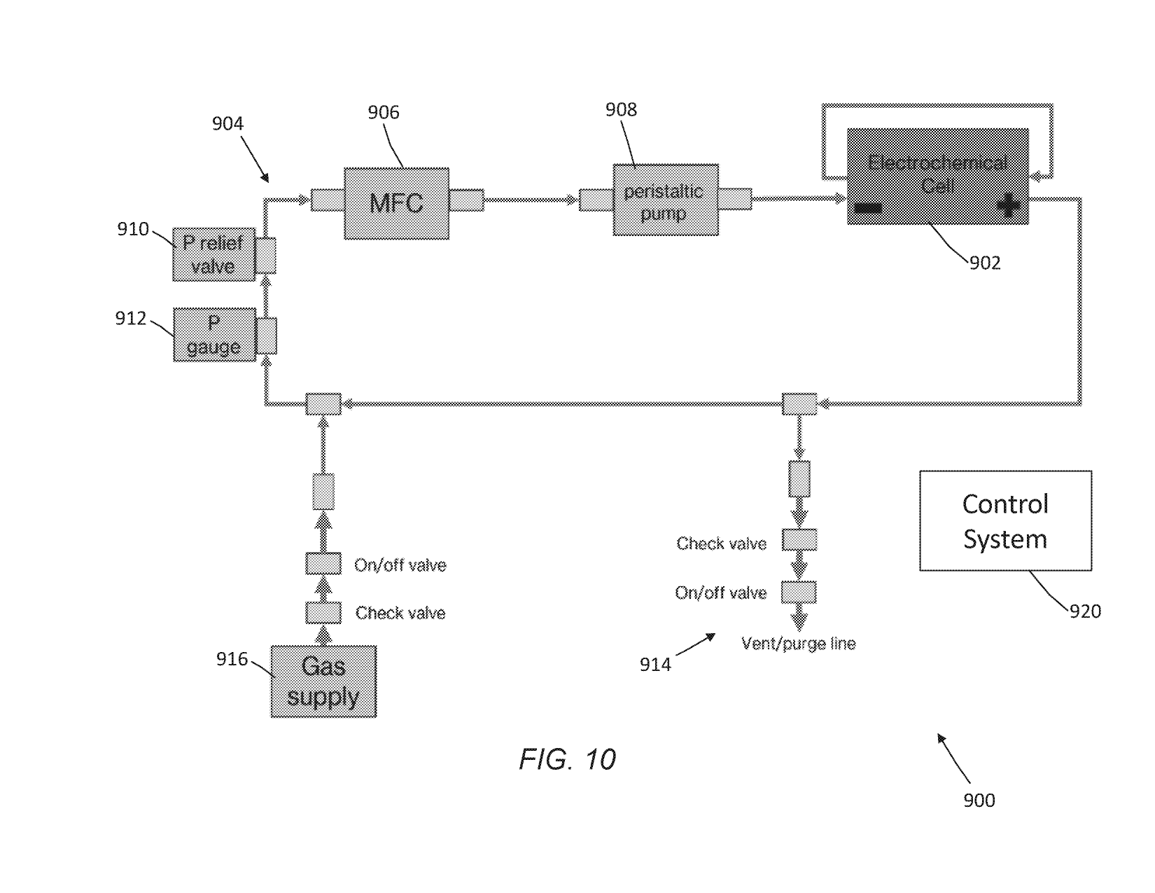

FIG. 9 is a perspective view of the assembled bench-scale electrochemical system 900 according to this example. The experimental system 900 includes an electrochemical cell 902 along with a gas loop for moving hydrogen between the cathode and anode. According to the example, the gas loop, also referred to herein as the hydrogen loop, is provided by external tubing, pumps, and other components, and extends from the cell’s cathode compartment to the cell’s anode compartment. FIG. 10 is a schematic illustration detailing the configuration of the hydrogen loop 904 connected to the electrochemical cell 902 within the system 900. The schematic outlines the hydrogen flow loop, which in this example includes a mass flow controller (MFC) 906, a peristaltic pump 908, a pressure relief valve 910, a pressure gauge 912, and other valving connecting a vent/purge line 914 and a gas supply 916. A control system 920, abstractly represented, controls various aspects of the system’s operation. In the case of the bench-scale experimental system 900, the control system 920 encompasses the collection of individual controls for each system component including, for example, a current/voltage source, the MFC 906, and various pumps, valves, and other parts in the hydrogen loop 904 and fluid loops of the cell.

The bench-scale electrochemical system 900 was constructed and operated under the following parameters to validate the hydrogen looping process according to various implementations of the disclosed technology:

Cell Hardware: The cell 902 featured titanium bipolar plates with serpentine gas and liquid flow channels. The total physical surface area of the electrodes and membranes was 1 in². The system was masked to provide a precise 1 cm² projected active area exposed to the fluids through the serpentine flow paths.

Fluid Dynamics: Three separate electrolyte solutions (0.1 - 6.0 M NaCl, 0.1 - 8.0 M HCl, and 0.1-10.0 M NaOH) were continuously recirculated through their respective compartments in the cell 902. The flow rate for each liquid loop was maintained at 10 mL/min.

Operating Conditions: The system 900 may be operated across a range of temperatures (5 °C to 40 °C). Gas pressure within the cell 902 was maintained between 0.1 and 10 PSIG.

Electrode Specifications: Two different Gas Diffusion Electrodes (GDEs) with Pt catalyst loading were tested to compare performance and efficiency. One electrode was a Carbon Cloth electrode with a 0.5 mg/cm² 60% Platinum on Vulcan catalyst loading. A Carbon Paper electrode with a much higher 4 mg/cm² Platinum Black catalyst loading was also tested. Gas diffusion electrodes of varying catalyst loading (0.05 mg/cm² to 4 mg/cm²) may be used.

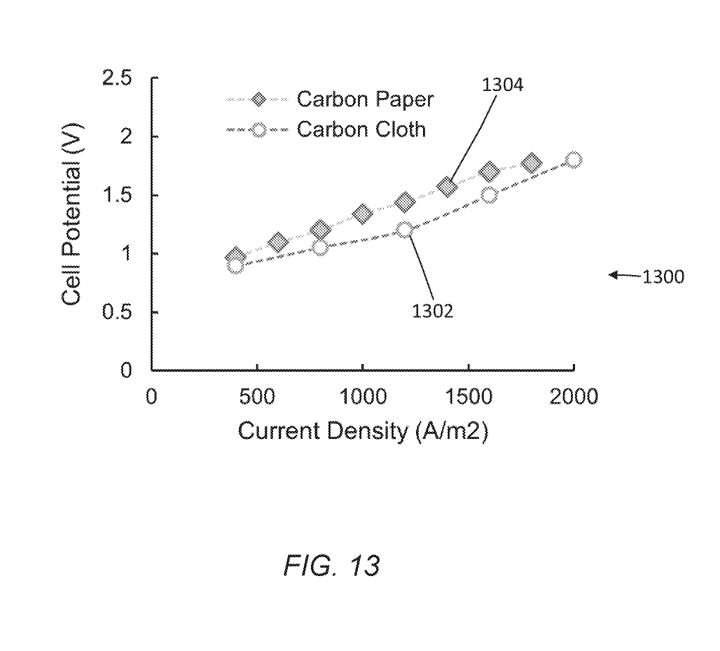

As demonstrated in the steady-state data in FIG. 13, the Carbon Cloth electrode yielded superior operational performance (e.g., lower cell pair potential) despite having a significantly lower platinum catalyst loading. The results highlight the efficiency of the chosen materials in this example system architecture and the low catalyst loading practically required.

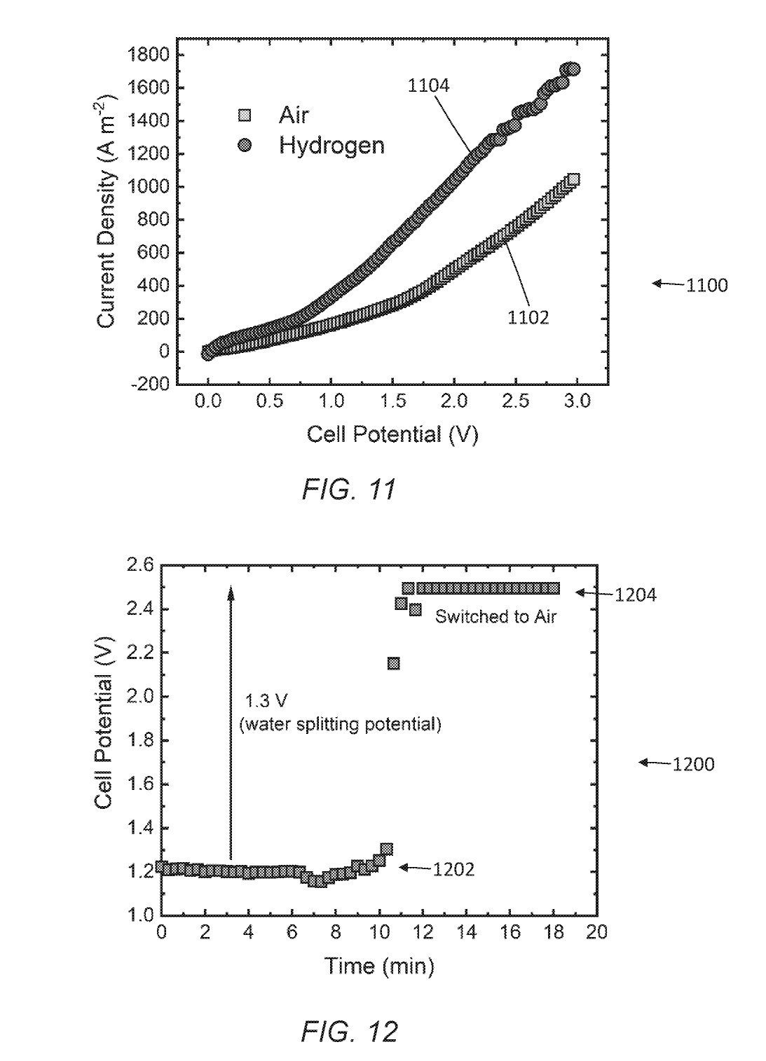

FIGS. 11, 12, and 13 are graphs of experimental data recorded during operation of the electrochemical system 900.

FIG. 11 is a graph 1100 depicting linear sweep voltammetry (LSV) profiles of the cell 902 operating with air 1102 versus hydrogen 1104 flowing through the gas loop 904. The data was collected at a 20 mV/s scan rate. The graph 1100 demonstrates significantly higher current densities at lower cell potentials for the hydrogen profile 1104 when compared to the air profile 1102.

FIG. 12 is a graph 1200 depicting the results of a hydrogen to air transition test in terms of cell potential over time. A graph showing the cell potential over time. During a first phase 1202, the cell 902 runs utilizing the hydrogen loop with HER/HOR reactions. The hydrogen loop is then opened up to air, causing the cell potential to immediately increase by approximately 1.3 V during a second phase 1204. The jump in potential clearly demonstrates the transition from HER/HOR to HER/OER (water splitting) and proves the substantial energy savings of the closed hydrogen loop.

FIG. 13 is a graph 1300 depicting the steady-state cell potential for the Carbon Cloth gas diffusion electrode 1302 and the Carbon Paper gas diffusion electrode 1304 at varying current densities (galvanostatic operation). As can be seen from the data, the Carbon Cloth GDE 1302 demonstrated a lower cell potential compared to the Carbon Paper GDE 1304 across a range of current densities from 500 to 2000 A/m².

Although the disclosure has been described with reference to certain implementations and embodiments, persons skilled in the art will recognize that changes may be made in form and detail without departing from the spirit and scope of the disclosed apparatus, systems and methods.

What is claimed is:

1. An electrochemical system for generating acid and base solutions, comprising:
an anode compartment comprising an anode configured to perform a hydrogen oxidation reaction;
a cathode compartment comprising a cathode configured to perform a hydrogen evolution reaction;
an acid compartment;
a base compartment;
one or more ion-exchange membranes positioned between the acid compartment and the base compartment; and
a hydrogen circulation loop configured to transfer hydrogen gas between the cathode and anode compartments,
wherein the system is configured to generate an acidic solution in the acid compartment and a basic solution in the base compartment during operation.

2. The system of claim 1, wherein the one or more ion-exchange membranes comprise one or more of a cation-exchange membrane, an anion-exchange membrane, and a bipolar membrane.

3. The system of claim 1 or claim 2, further comprising a plurality of brine compartments positioned between the acid compartment and the base compartment, wherein at least one of the ion-exchange membranes is positioned between the acid compartment and the plurality of brine compartments, and wherein at least another one of the ion-exchange members is positioned between the base compartment and the plurality of brine compartments.

4. The system of any one of claim 1-3, further comprising a reverse operational mode in which the polarity of the electrodes is reversed to mitigate scaling and/or fouling.

5. The system of any one of claims claim 1-4, wherein protons produced in the acid compartment are reacted with carbonate or bicarbonate ions to release carbon dioxide gas, while simultaneously regenerating an alkaline solution.

6. The system of any one of claims claim 1-5, further comprising a second anode, wherein the anode and the second anode share the cathode.

7. An electrochemical system for generating acid and base solutions, comprising:
a capacitive electrode configured to sorb anions from an input liquid during charging;
a cathode configured to perform a hydrogen evolution reaction (HER) to generate a basic solution and hydrogen gas during charging;
a control system configured to alternately charge and discharge the capacitive electrode; and
an anode configured to perform a hydrogen oxidation reaction (HOR) or oxygen evolution reaction (OER) during discharge, wherein acid is generated during discharge.

8. The system of claim 7, wherein the capacitive electrode comprises an activated carbon, battery electrode, intercalation electrode, or a pseudocapacitive material.

9. The system of claim 7 or 8, wherein the system operates without ion-exchange membranes during charging and discharging.

10. The system of any one of claims claim 7-9, wherein a base is generated during the charging phase of the capacitive electrode.

11. The system of any one of claims claim 7-10, wherein hydrogen is generated during the charging phase of the capacitive electrode.

12. The system of any one of claim 7-11, wherein energy stored during the charging phase comprises energy stored in the capacitive electrode and/or energy from stored hydrogen is partially or fully recovered during discharging.

13. The system of any one of claims claim 7-12, wherein the energy stored in the capacitor and/or hydrogen is utilized to power an external load.

14. The system of any one of claims claim 7-13, wherein the energy stored in the capacitor and/or hydrogen is utilized to supply energy during periods of intermittency in renewable energy supply.

15. The system of any one of claims claim 7-14, wherein hydrogen generated during charging is directed to the anode during discharging to perform a hydrogen oxidation reaction.

16. The system of any one of claims claim 7-15, wherein protons produced during discharging are reacted with carbonate or bicarbonate ions to release a pure carbon dioxide gaseous product.

17. The system of any one of claims claim 7-16, further comprising a reverse operational mode in which the polarity of the electrodes is reversed to mitigate scaling or fouling.

18. A zinc redox electrochemical system for generating acid and base solutions from a saline or brine feed, comprising:
an anode configured to oxidize zinc metal to Zn²⁺ ions during a first operational mode;
a cathode configured to perform a hydrogen evolution reaction (HER) to generate a basic solution during the first operational mode;
a zinc ion solution in contact with the anode;
an ion-exchange membrane separating the anode and cathode compartments; and
a second operational mode in which the polarity of anode and the cathode is reversed for zinc electrode replating, thereby reducing Zn²⁺ to zinc metal, generating an acid solution, and optionally oxidizing hydrogen or performing oxygen evolution reaction at the anode.

19. The system of claim 18, further comprising a brine compartment positioned between the anode and cathode compartments and separated from each by ion-exchange membranes.

20. The system of claim 18 or claim 19, wherein zinc metal is regenerated in the anode compartment during discharge via reduction of Zn²⁺ ions.

21. The system of any one of claims claim 18-20, wherein hydrogen generated during charging is directed to the anode and utilized during discharging to perform a hydrogen oxidation reaction.

22. The system of any one of claims claim 18-21, wherein protons produced during discharging are reacted with carbonate or bicarbonate ions to release a pure carbon dioxide gaseous product.

23. The system of any one of claims claim 18-22, wherein the second operational mode is performed to mitigate scaling or fouling.

24. An atmospheric carbon dioxide removal process comprising one or more of the systems of claim 1, claim 7, and claim 18.

25. A carbon capture process comprising the system of claim 7, where during periods of intermittency in renewable power, the capacitive cell is discharged to provide power to an alternative method of base generation, thereby sustaining continuous base generation.
